(19) United States
(12) Patent Application Publication
(10) Pub. No.: US 2014/0109234 A1
(43) Pub. Date: Apr. 17, 2014

(54) SYSTEMS AND METHODS FOR LIMITING THE NUMBER OF ELECTRONIC DEVICES ACCESSING DIGITAL RIGHTS MANAGEMENT (DRM) CONTENT IN A PORTABLE MEMORY DEVICE

(71) Applicant: CONDEL INTERNATIONAL TECHNOLOGIES INC., George Town (KY)

(72) Inventors: Yeu-Chung LIN, Chang-hua (TW); Chih-Sheng SU, Zhubei City (TW)

(73) Assignee: CONDEL INTERNATIONAL TECHNOLOGIES INC., George Town (KY)

(21) Appl. No.: 13/651,635

(22) Filed: Oct. 15, 2012

(51) Int. Cl. G06F 21/24

(52) U.S. Cl. 726/27

(57) ABSTRACT

A system for managing access to DRM content is provided with a portable memory device and an electronic device coupled to the portable memory device. The portable memory device includes a public area for storing software and the DRM content, and a hidden area for storing data on predetermined addresses among all addresses in the hidden area. The software is executed by the electronic device for obtaining a first identification associated with an electronic device in response to the portable memory device being coupled to the electronic device, and only allowing the electronic device to access the DRM content in response to the first identification being equal to the data on one of the predetermined addresses, or the first identification being different from the data on the predetermined addresses and the data on one of the predetermined addresses being equal to a predetermined number.

### BACKGROUND OF THE INVENTION

1. Field of the Invention

The invention generally relates to the field of access control for data content in portable memory devices, and more particularly, to systems and methods for limiting the number of electronic devices accessing Digital Rights Management (DRM) content in a portable memory device.

2. Description of the Related Art

In recent years, there has been an exponential growth in the development of semiconductor memory technology and in the use of the Internet. Coupled with the advancements in computing technology, software programs, music, books, video games, and even full-length movies, have become widely available in high-quality, easily reproducible and easily transmitted digital formats. Correspondingly, various methods have been developed for preventing the spread of rampant piracy and unauthorized distribution, by controlling the access to the digital content which is usually carried in portable memory devices. Generally, the methods may be divided into the following groupings.

### Hardware Access Control

This method, as described in U.S. Pat. No. 5,592,651 by Rackman et al., requires a portable memory (generally refers to a Write-Many Read-Many (WMRM) memory) device with protected content to be additionally equipped with a Write-Once Read-Many (WORM) Memory chip in which the storage volume is exactly the size for storing a fixed number of Unique Identifications (UIDs) of electronic devices allowed to access the WORM memory chip. When the portable memory device is coupled to an electronic device, the software stored in the portable memory device is executed to compare the UID of the electronic device with the UIDs in the WORM memory chip. If a match is found, the software allows the electronic device to access the protected content in the portable memory device. Otherwise, if no match is found, the software attempts to write the UID of the electronic device into the WORM memory chip. The write attempt is granted and the electronic device is allowed to access the protected content, only if there's a space in the WORM memory chip for storing the UID of the electronic device.

However, this method has certain drawbacks. For instance, having a general portable memory device to be equipped with an additional WORM memory chip increases costs. Also, the complexity of packaging, connection layout designs, and microcontroller operations regarding the equipment of the additional WORM memory chip increases significantly.

### Software Access Control with UID Domain

According to the specifications of Digital Rights Management (DRM), a consumer may upload the UIDs of electronic devices for rightful use of protected content, during the process of issuing Rights Object (RO) by the Rights Management Module (RMM) in a DRM server. Thus, the uploaded UIDs form a specific domain for the registered electronic devices to be able to access protected content.

This method, however, requires the electronic device to be online in the network where the DRM server (also referred to as a backstage server) is located, so that the DRM server may check if the UID of the electronic device is within the specific domain. Unfavorably, this limitation creates inconvenience for consumers because one major feature of the portable memory device is that it may be used offline.

### Software Access Control with multiple ROs

A portable memory device may be preloaded with a fixed number of ROs, and each RO may be used by the DRM agent in an electronic device only when it is moved to the electronic device, wherein each RO may be moved only once. In addition, the protected content is accessible under the condition in which the portable memory device is coupled to the electronic device. As a result, a consumer may move the RO(s) from the portable memory device to any electronic device in which the protected content is rightfully used, while the protected content may remain accessible to only one electronic device at a time. Thus, over licensing may be prevented. However, the implementation of this method has a rather high technical threshold, and allowing a consumer to move the RO(s) at will, may cause operational errors.

### BRIEF SUMMARY OF THE INVENTION

In one aspect of the invention, a system for managing access to DRM content is provided. The system comprises a portable memory device and an electronic device. The portable memory device comprises a public area for storing software and the DRM content, and a hidden area for storing data on predetermined addresses among all addresses in the hidden area. The electronic device is coupled to the portable memory device. The software is executed by the electronic device for obtaining a first identification associated with an electronic device in response to the portable memory device being coupled to the electronic device, and only allowing the electronic device to access the DRM content in response to the first identification being equal to the data on one of the predetermined addresses, or the first identification being different from the data on the predetermined addresses and the data on one of the predetermined addresses being equal to a predetermined number.

In another aspect of the invention, a method for managing access to DRM content is provided. The method comprises the steps of providing a portable memory device comprising a public area for storing the DRM content, and a hidden area for storing data on predetermined addresses among all addresses in the hidden area; obtaining a first identification associated with an electronic device in response to the portable memory device being coupled to the electronic device; and only allowing the electronic device to access the DRM content in response to the first identification being equal to the data on one of the predetermined addresses, or the first identification being different from the data on the predetermined addresses and the data on one of the predetermined addresses being equal to a predetermined number.

Other aspects and features of the invention will become apparent to those with ordinary skill in the art upon review of the following descriptions of specific embodiments of the systems and methods for managing access to DRM content.

### BRIEF DESCRIPTION OF DRAWINGS

The invention can be more fully understood by reading the subsequent detailed description and examples with references made to the accompanying drawings, wherein:

FIG. 1 is a block diagram illustrating a portable memory device according to an embodiment of the invention;

FIG. 2 is a flow chart illustrating the initialization of a portable memory device by a digital content company according to an embodiment of the invention; and

FIG. 3 is a flow chart illustrating the method for managing access to DRM content according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

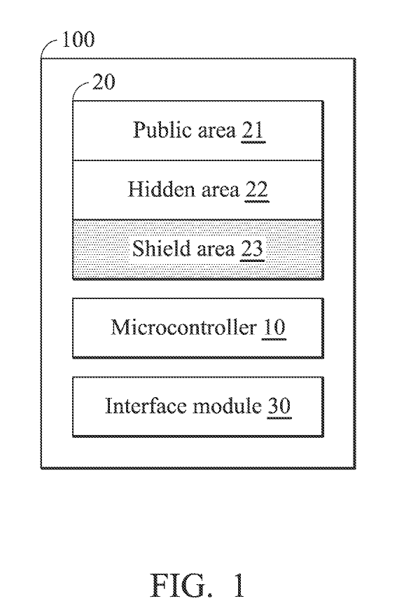

FIG. 1 is a block diagram illustrating a portable memory device according to an embodiment of the invention. The portable memory device 100 may be a WMRM memory device, such as a Secure Digital (SD) card, a Micro SD card, a Universal Serial Bus (USB) flash drive, or a Solid State Drive (SSD). The portable memory device 100 comprises a microcontroller 10, a data storage 20, and an interface module 30. The microcontroller 10 is responsible for controlling the operations of hardware, firmware, and/or software on the portable memory device 100. The data storage 20 comprises a public area 21, a hidden area 22, and a shield area 23 isolated from the public area 21 and the hidden area 22. The public area 21 is used for storing a Number of Electronic Device Control Software (hereinafter to be referred to as NEDCS for brevity) and DRM content, and is accessible to general consumers. The NEDCS stored in the public area 21 may be machine code (compiled under a specific operating system) which when loaded and executed by a machine, is configured to perform the method for managing access to DRM content as proposed in the invention. The hidden area 22 is used for storing data on predetermined addresses among all addresses in the hidden area, and is accessible via a certain library/machine code provided by the manufacturer of the portable memory device 100. The shield area 23 is used for storing the identification of the portable memory device 100. Specifically, as isolated from the public area 21 and the hidden area 22, the shield area 23 is not within the normal memory cell, i.e., not accessible even by bit-to-bit mirror copying, and is only accessible via a custom firmware for the microcontroller 10. The interface module 30 is responsible for providing a communication interface, such as an SD interface, a micro SD interface, a USB interface, or an SSD interface, to an external electronic device, such as, a Personal Computer (PC), a laptop, a tablet PC, a smart phone, a multimedia player, a portable gaming device, or others.

Note that, the shield area 23 is created and the UID of the portable memory device 100 is imprinted therein by the memory device company during the manufacturing process. In addition, the division of the public area 21 and the hidden area 22 is performed using an initialization firmware provided by the microcontroller company during an initialization procedure, so that the manufacturer of the portable memory device 100 may create and read/write the hidden area 22. For the convenience of the purchasing company, e.g., a digital content company, the manufacturer of the portable memory device 100 prepares a certain library/machine code for the purchasing company to be able to access the hidden area 22, while the shield area 23 remains accessible only via the custom firmware for reading purpose only. In other words, general consumers may not read/write data at will in the hidden area 22 and the shield area 23.

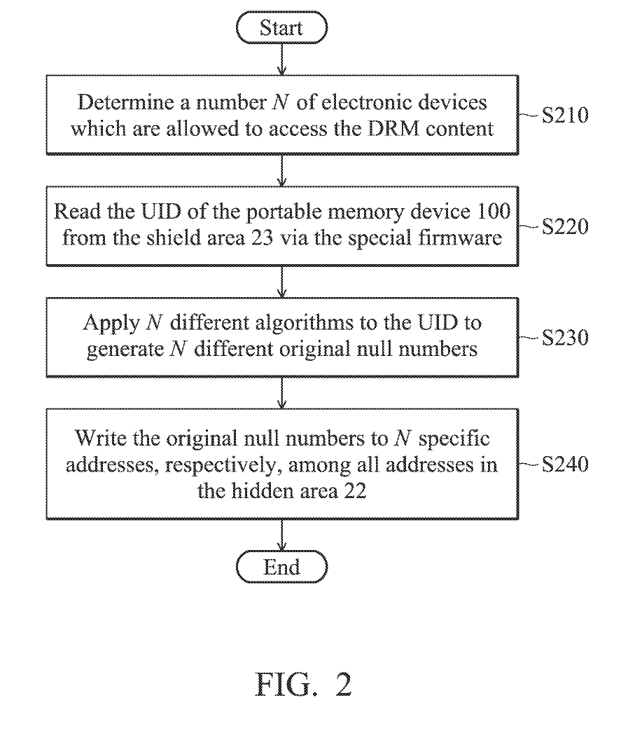

Before the portable memory device 100 is delivered to consumers, it may be further initialized by the digital content company with a series of processes as shown in FIG. 2. At first, a number N of electronic devices which are allowed to access the DRM content in the public area 21 is determined (step S210). The microcontroller 10 reads the UID of the portable memory device 100 from the shield area 23 via the custom firmware provided by the microcontroller company (step S220), and then applies N different algorithms to the UID to generate N different numbers (referred to herein as original null numbers) (step S230). Please note that the original null numbers are different from an empty number which has a value of zero or consists of a plurality of zeros, and instead, they are special numbers generated by specific algorithms. To further secure the UID of the portable memory device 100, in another embodiment, the microcontroller 10 may first apply an algorithm to the UID to generate a new ID, and then apply N different algorithms to the new ID to generate the original null numbers. Each of the applied algorithms may be a respective hash function, predefined equation, or others, for mapping the UID to a completely different number. Next, the microcontroller 10 writes the original null numbers to N specific addresses, respectively, among all addresses in the hidden area 22 via the library/machine code (step S240). For example, assuming that N equals to 3 and there are totally 15 addresses in the hidden area 22, only 3 addresses are selected from the 15 addresses in the hidden area 22 for the original null numbers to be written to. That is, only the 3 specific addresses hold meaning data, i.e., the original null numbers. Therefore, advantageously, even if a third person may acquire the library/machine code for accessing the hidden area 22, he/she still does not know where the original null numbers are as the remaining space may be filled with meaningless data.

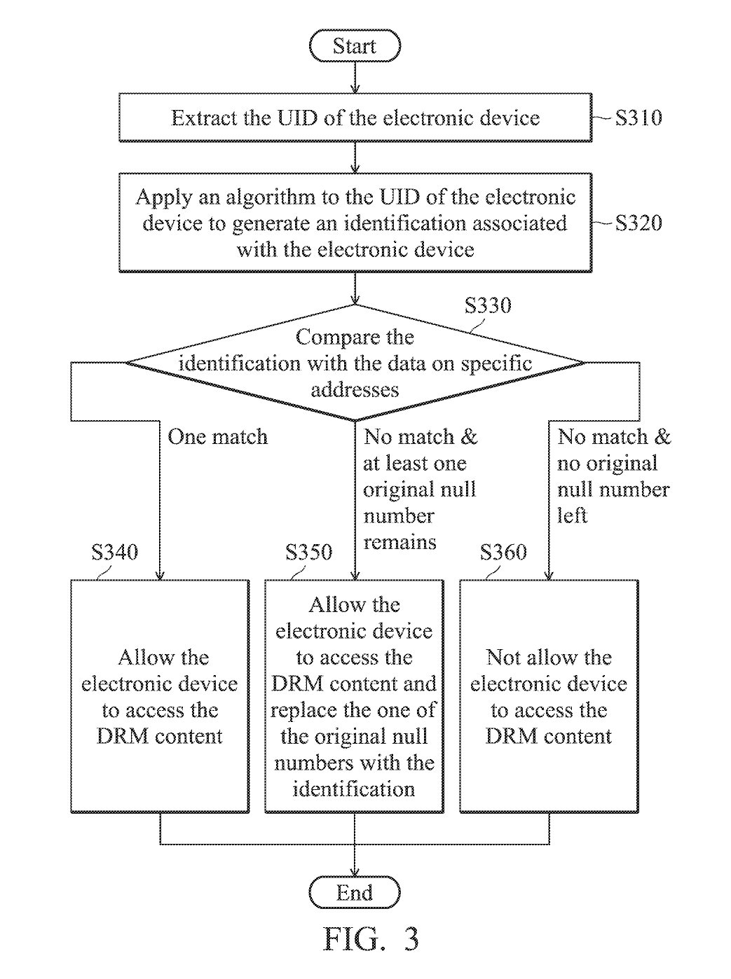

After that, when the portable memory device 100 is delivered to consumers and coupled to an electronic device, the NEDCS in the portable memory device 100 is executed by the electronic device for performing the method for managing access to DRM content as proposed in the invention. FIG. 3 is a flow chart illustrating the method for managing access to DRM content according to an embodiment of the invention. To begin, the NEDCS may obtain an identification associated with an electronic device. Specifically, the NEDCS extracts the UID of the electronic device (step S310) and then applies an algorithm to the UID of the electronic device to generate the identification associated with the electronic device (step S320). The electronic device may have one or more UIDs, such as a Medium Access Control (MAC) number, an OS license key (e.g., Microsoft License Key), an International Mobile Subscriber Identification (IMSI), an International Mobile Equipment Identification (IMEI), or any identification suitable for the identifying purpose, and the algorithm may be applied to a single UID or multiple UIDs of the electronic device to generate the identification associated with the electronic device.

In another embodiment for step S320, the algorithm may be applied to both of the UID(s) of the electronic device and the UID of the portable memory device 100 to generate the identification associated with the electronic device, and the NEDCS may read the UID of the portable memory device 100 from the shield area 23 by calling an Application Programming Interface (API) provided by the microcontroller company to invoke the microcontroller 10 to access the shield area 23 via the custom firmware provided by the microcontroller company.

Subsequently, the NEDCS compares the identification associated with the electronic device with the data on the specific addresses where the original null numbers were initially written (step S330). If a match is found, the electronic device is allowed to access the DRM content in the public area 21 (step S340). If no match is found and at least one of the original null numbers remains on the corresponding address, the electronic device is allowed to access the DRM content in the public area 21 and one of the original null numbers is replaced with the identification associated with the electronic device (step S350). Otherwise, if no match is found and the data on the specific addresses is no longer equal to any one of the original null numbers, then the electronic device is not allowed to access the DRM content in the public area 21 (step S360). Thus, the number of electronic devices accessing the DRM content may be limited.

To further clarify, the NEDCS is preconfigured, before it is compiled under a specific operating system, with the information concerning the library/machine code for accessing the hidden area 22, the specific addresses for storing the original null numbers, the library/machine code for invoking the microcontroller 10 to read the UID of the portable memory device 100, and the algorithm for generating the identification associated with the electronic device, so that it may access the data stored in the hidden area 22 and the shield area 23 for performing the method for managing access to DRM content. It is to be understood that, since the NEDCS is compiled, the preconfigured information should be secure.

It is to be understood that, unlike the conventional designs, the storage device used for carrying the protected content in the invention, i.e., the portable memory device 100, is a commodity memory, such as an SD card, a Micro SD card, a USB flash drive, or an SSD. Since no custom microcontroller, custom memory chip, or additional WORM memory is required, costs and engineering efforts are saved. Also, different digital content companies may easily select different algorithms for generating the original null numbers and the identifications for electronic devices to ensure the confidentiality therebetween. In addition, the designs of the invention, such as the shield area 23 not being accessible even by bit-to-bit mirror copying, and the original null numbers being written to specific addresses among all addresses in the hidden area 22, provide highly secure protection for content.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A system for managing access to Digital Rights Management (DRM) content, comprising:
a portable memory device comprising a public area for storing software and the DRM content, and a hidden area for storing data on predetermined addresses among all addresses in the hidden area; and
an electronic device coupled to the portable memory device,
wherein the software is executed by the electronic device for obtaining a first identification associated with the electronic device in response to the portable memory device being coupled to the electronic device, and only allowing the electronic device to access the DRM content in response to the first identification being equal to the data on one of the predetermined addresses, or the first identification being different from the data on the predetermined addresses and the data on one of the predetermined addresses being equal to a predetermined number.

2. The system of claim 1, wherein the software is further executed by the electronic device for:
in response to the first identification being different from the data on the predetermined addresses and the data on one of the predetermined addresses being equal to a predetermined number, replacing the data on the one of the predetermined addresses with the first identification.

3. The system of claim 1, wherein the portable memory device is a Secure Digital (SD) card, a Micro SD card, a Universal Serial Bus (USB) flash drive, or a Solid State Drive (SSD).

4. The system of claim 1, wherein the portable memory further comprises a shield area, isolated from the public area and the hidden area, for storing a second identification of the portable memory device, and wherein the shield area is not accessible by bit-to-bit mirror copying and is only accessible via a custom firmware for a microcontroller of the portable memory device.

5. The system of claim 4, wherein the predetermined number is generated by selecting an algorithm corresponding to the one of the predetermined addresses, and applying the algorithm to the second identification.

6. The system of claim 4, wherein the predetermined number is generated by selecting a first algorithm corresponding to the one of the predetermined addresses, applying the first algorithm to the second identification to generate a third identification, and applying a second algorithm to the third identification.

7. The system of claim 1, wherein the first identification is obtained by applying an algorithm to a third identification of the electronic device.

8. The system of claim 4, wherein the first identification is obtained by applying an algorithm to the second identification and a third identification of the electronic device.

9. The system of claim 4, wherein the first identification is obtained by applying a first algorithm to the second identification to generate a third identification, and applying a second algorithm to the third identification and a fourth identification of the electronic device.

10. A method for managing access to Digital Rights Management (DRM) content, comprising:
providing a portable memory device comprising a public area for storing the DRM content, and a hidden area for storing data on predetermined addresses among all addresses in the hidden area;
obtaining a first identification associated with an electronic device in response to the portable memory device being coupled to the electronic device; and
only allowing the electronic device to access the DRM content in response to the first identification being equal to the data on one of the predetermined addresses, or the first identification being different from the data on the predetermined addresses and the data on one of the predetermined addresses being equal to a predetermined number.

11. The method of claim 10, further comprising:
in response to the first identification being different from the data on the predetermined addresses and the data on one of the predetermined addresses being equal to a predetermined number, replacing the data on the one of the predetermined addresses with the first identification.

12. The method of claim 10, wherein the portable memory device is a Secure Digital (SD) card, a Micro SD card, a Universal Serial Bus (USB) flash drive, or a Solid State Drive (SSD).

13. The method of claim 10, wherein the portable memory further comprises a shield area, isolated from the public area and the hidden area, for storing a second identification of the portable memory device, and wherein the isolated shield area is not accessible by bit-to-bit mirror copying and is only accessible via a custom firmware for a microcontroller of the portable memory device.

14. The method of claim 13, wherein the predetermined number is generated by selecting an algorithm corresponding to the one of the predetermined addresses, and applying the algorithm to the second identification.

15. The method of claim 13, wherein the predetermined number is generated by selecting a first algorithm corresponding to the one of the predetermined addresses, applying the first algorithm to the second identification to generate a third identification, and applying a second algorithm to the third identification.

16. The method of claim 10, wherein the first identification is obtained by applying an algorithm to a third identification of the electronic device.

17. The method of claim 13, wherein the first identification is obtained by applying an algorithm to the second identification and a third identification of the electronic device.

18. The method of claim 13, wherein the first identification is obtained by applying a first algorithm to the second identification to generate a third identification, and applying a second algorithm to the third identification and a fourth identification of the electronic device.
